(19) United States
(12) Patent Application Publication
(10) Pub. No.: US 2025/0202663 A1
(43) Pub. Date: Jun. 19, 2025

(54) TRANSMISSION PROCESSING METHOD AND APPARATUS, AND DEVICE

(71) Applicant: VIVO MOBILE COMMUNICATION CO., LTD., Dongguan (CN)

(72) Inventors: Zuolong YING, Dongguan (CN); Kai WU, Dongguan (CN); Dongru LI, Dongguan (CN)

(21) Appl. No.: 19/054,996

(22) Filed: Feb. 17, 2025

Related U.S. Application Data
(63) Continuation of application No. PCT/CN2023/113014, filed on Aug. 15, 2023.

(30) Foreign Application Priority Data
Aug. 18, 2022 (CN) 202210994028.6

(51) Int. Cl. H04L 5/00; H04B 7/22; H04W 72/0446; H04W 72/0453

(52) U.S. Cl. CPC H04L 5/0053; H04B 7/22; H04W 72/0446; H04W 72/0453

(57) ABSTRACT

A transmission processing method and apparatus, and a device in the field of communication technologies are disclosed. The method includes: determining, by a backscatter communication device, a transmission configuration of a second part of information based on a first part of information, wherein the first part of information and the second part of information are information related to uplink reporting triggered by the backscatter communication device; and receiving and/or sending, by the backscatter communication device, the second part of information based on the transmission configuration.

### CROSS-REFERENCE TO RELATED APPLICATIONS

This application is a bypass continuation application of International Application No. PCT/CN2023/113014, filed on Aug. 15, 2023, which claims the benefit of and priority to Chinese Patent Application No. 202210994028.6, filed on Aug. 18, 2022, both of which are incorporated by reference in their entireties herein.

### TECHNICAL FIELD

This application relates to the field of communication technologies and, in particular, to a transmission processing method and apparatus, and a device.

### BACKGROUND

With respect to the development of communication and networking technologies, backscatter communication is being applied to more and more scenarios. Backscatter communication includes a backscatter communication device using radio frequency signals from another device or in an environment for signal modulation to transmit information of the backscatter communication device. A conventional backscatter communication system includes a gNB (next generation NodeB, gNB)/reader (reader) that sends signals, and a backscatter communication device (for example, a tag (tag)) that reflects signals.

The gNB/reader needs to obtain data from the backscatter communication device by performing an inventory, where the gNB/reader triggers, in a downlink direction, reporting by the backscatter communication device. For example, in an example of a fire alarm sensor, passive (passive) tags are deployed to reduce costs for deploying a large quantity of tags. A gNB/reader obtains information from the tags in an inventory manner.

### BRIEF SUMMARY

Embodiments of this application provide a transmission processing method and apparatus, and a device.

According to a first aspect, a transmission processing method is provided. The method includes:
determining, by a backscatter communication device, a transmission configuration of a second part of information based on a first part of information, where the first part of information and the second part of information are information related to uplink reporting triggered by the backscatter communication device; and
receiving and/or sending, by the backscatter communication device, the second part of information based on the transmission configuration.

According to a second aspect, a transmission processing apparatus is provided, including:
a first determining module, configured to determine a transmission configuration of a second part of information based on a first part of information, where the first part of information and the second part of information are information related to uplink reporting triggered by a backscatter communication device; and
a first transceiver module, configured to receive and/or send the second part of information based on the transmission configuration.

According to a third aspect, a transmission processing method is provided. The method includes:
determining, by a first device, a transmission configuration of a second part of information based on a first part of information, where the first part of information and the second part of information are information related to uplink reporting triggered by a backscatter communication device; and
receiving and/or sending, by the first device, the second part of information based on the transmission configuration.

According to a fourth aspect, a transmission processing apparatus is provided, including:
a second determining module, configured to determine a transmission configuration of a second part of information based on a first part of information, where the first part of information and the second part of information are information related to uplink reporting triggered by a backscatter communication device; and
a second transceiver module, configured to receive and/or send the second part of information based on the transmission configuration.

According to a fifth aspect, a backscatter communication device is provided. The backscatter communication device includes a processor and a memory. The memory stores a program or instructions executable on the processor. When the program or the instructions are executed by the processor, the steps of the method according to the first aspect are implemented.

According to a sixth aspect, a backscatter communication device is provided, including a processor and a communication interface. The processor is configured to determine a transmission configuration of a second part of information based on a first part of information, where the first part of information and the second part of information are information related to uplink reporting triggered by the backscatter communication device. The communication interface is configured to receive and/or send the second part of information based on the transmission configuration.

According to a seventh aspect, a communication device is provided. The communication device includes a processor and a memory. The memory stores a program or instructions executable on the processor. When the program or the instructions are executed by the processor, the steps of the method according to the third aspect are implemented.

According to an eighth aspect, a communication device is provided, including a processor and a communication interface. The processor is configured to determine a transmission configuration of a second part of information based on a first part of information, where the first part of information and the second part of information are information related to uplink reporting triggered by a backscatter communication device. The communication interface is configured to receive and/or send the second part of information based on the transmission configuration.

According to a ninth aspect, a transmission processing system is provided, including a backscatter communication device and a first device. The backscatter communication device may be configured to perform the steps of the transmission processing method according to the first aspect, and the first device may be configured to perform the steps of the transmission processing method according to the third aspect.

According to a tenth aspect, a readable storage medium is provided. The readable storage medium stores a program or instructions. When the program or the instructions are executed by a processor, the steps of the method according to the first aspect are implemented, or the steps of the method according to the third aspect are implemented.

According to an eleventh aspect, a chip is provided. The chip includes a processor and a communication interface. The communication interface is coupled to the processor. The processor is configured to run a program or instructions, to implement the method according to the first aspect, or to implement the method according to the third aspect.

According to a twelfth aspect, a computer program/program product is provided. The computer program/program product is stored in a storage medium. The computer program/program product is executed by at least one processor, to implement the steps of the method according to the first aspect, or to implement the steps of the method according to the third aspect.

### BRIEF DESCRIPTION OF THE DRAWINGS

FIG. 1 is a block diagram of a wireless communication system;

FIG. 2 is a first schematic flowchart of a transmission processing method according to an embodiment of this application;

FIG. 3 is a diagram of 4-step uplink reporting according to an embodiment of this application;

FIG. 4 is a diagram of 2-step uplink reporting according to an embodiment of this application;

FIG. 5 is a diagram of determining a transmission resource of third information according to an embodiment of this application;

FIG. 6 is a first diagram of determined transmission resources according to an embodiment of this application;

FIG. 7 is a second schematic flowchart of a transmission processing method according to an embodiment of this application;

FIG. 8 is a first module diagram of a transmission processing apparatus according to an embodiment of this application;

FIG. 9 is a second module diagram of a transmission processing apparatus according to an embodiment of this application;

FIG. 10 is a first diagram of a structure of a communication device according to an embodiment of this application; and

FIG. 11 is a second diagram of a structure of a communication device according to an embodiment of this application.

### DETAILED DESCRIPTION

Technical solutions in embodiments of this application are clearly described in the following with reference to accompanying drawings in embodiments of this application. Apparently, the described embodiments are some rather than all of embodiments of this application. All other embodiments derived by a person of ordinary skill in the art based on embodiments of this application fall within the protection scope of this application.

In the specification and the claims of this application, terms such as “first” and “second” are used to distinguish between similar objects rather than to describe a specific sequence or order. It should be understood that terms used in this way are exchangeable in a proper case, so that embodiments of this application can be implemented in an order other than the orders illustrated or described herein. The objects distinguished by “first” and “second” are usually of a same category, and a quantity of the objects is not limited. For example, there may be one or more first objects. In addition, in the specification and the claims, “and/or” indicates at least one of connected objects, and the character “/” usually indicates an “or” relationship between associated objects.

It should be noted that the technologies described in embodiments of this application are not limited to a long term evolution (Long Term Evolution, LTE)/LTE-advanced (LTE-Advanced, LTE-A) system, and may also be applied to other wireless communication systems such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), and other systems. Terms “system” and “network” in embodiments of this application are usually used interchangeably. The described technologies may be applied to the systems and radio technologies mentioned above, and may also be applied to other systems and radio technologies. A new radio (New Radio, NR) system is described in the following descriptions for example purposes, and NR terms are used in most of the following descriptions. However, the technologies may also be applied to applications other than an NR system application, for example, a 6^{th} generation (6^{th} Generation, 6G) communication system.

From a perspective of the gNB/reader, because a specific situation of each tag cannot be learned, data of a tag cannot be obtained in a timely manner during the inventory.

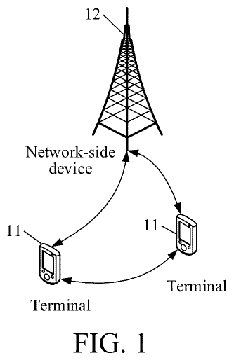

FIG. 1 is a block diagram of a wireless communication system to which an embodiment of this application is applicable. The wireless communication system includes terminals 11 and a network-side device 12. A terminal 11 may be a terminal-side device such as a mobile phone, a tablet personal computer (Tablet Personal Computer), a laptop computer (Laptop Computer) or a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (augmented reality, AR)/virtual reality (virtual reality, VR) device, a robot, a wearable device (Wearable Device), vehicle user equipment (Vehicle User Equipment, VUE), pedestrian user equipment (Pedestrian User Equipment, PUE), a smart household (home devices with a wireless communication function, such as a refrigerator, a television, a washing machine, or furniture), a game console, a personal computer (personal computer, PC), a teller machine, or a self-service machine. A wearable device includes a smartwatch, a smart band, smart headphones, smart glasses, smart jewelry (a smart bangle bracelet, a smart chain bracelet, a smart ring, a smart necklace, a smart anklet, a smart ankle chain, or the like), a smart wristband, smart clothing, or the like. It should be noted that a specific type of the terminal 11 is not limited in this embodiment of this application. The network-side device 12 may include an access network device or a core network device. An access network device may also be referred to as a radio access network device, a radio access network (Radio Access Network, RAN), a radio access network function, or a radio access network unit. An access network device may include a base station, a wireless local area network (Wireless Local Area Network, WLAN) access point, a WiFi node, or the like. A base station may be referred to as a NodeB, an evolved NodeB (eNB), an access point, a base transceiver station (Base Transceiver Station, BTS), a radio base station, a radio transceiver, a basic service set (Basic Service Set, BSS), an extended service set (Extended Service Set, ESS), a home NodeB, a home evolved NodeB, a transmitting receiving point (Transmitting Receiving Point, TRP), or another proper term in the art. Provided that same technical effects are achieved, the base station is not limited to a specific technical term. It should be noted that a base station in the NR system is only used as an example for description in embodiments of this application, but a specific type of base station is not limited.

A transmission processing method and apparatus, and a device provided in embodiments of this application are described in detail below by using some embodiments and application scenarios thereof with reference to the accompanying drawings.

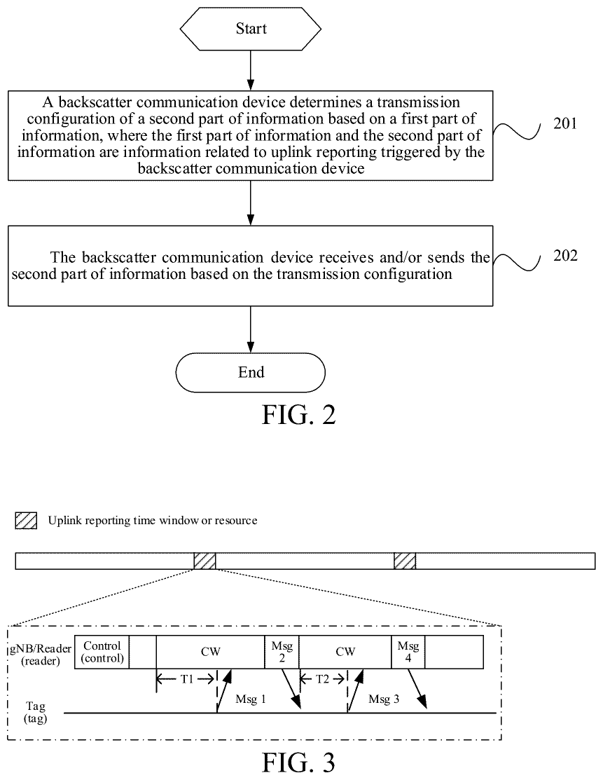

As shown in FIG. 2, a transmission processing method according to an embodiment of this application includes the following steps.

Step 201: A backscatter communication device determines a transmission configuration of a second part of information based on a first part of information, where the first part of information and the second part of information are information related to uplink reporting triggered by the backscatter communication device.

Herein, uplink reporting triggered by the backscatter communication device may be an autonomous reporting procedure triggered by the backscatter communication device in a specific situation, and may also be referred to as uplink initiated reporting (UpLink initiated reporting, UL initiated reporting). The first part of information and the second part of information are both information in the reporting procedure; and may be information received by the backscatter communication device, or may be information sent by the backscatter communication device. Thus, in this step, for autonomous uplink reporting triggered in the specific situation and performed by using a specific transmission resource, the backscatter communication device determines the transmission configuration of the second part of information based on the first part of information. The specific situation may be that the backscatter communication device has data pending uplink reporting.

Step 202: The backscatter communication device receives and/or sends the second part of information based on the transmission configuration.

In this step, the backscatter communication device can receive and/or send the second part of information based on the transmission configuration after determining the transmission configuration in step 201.

In this way, by performing steps 201 and 202, for autonomous uplink reporting triggered by the backscatter communication device in the specific situation, the backscatter communication device can determine the transmission configuration of the second part of information based on the first part of information, and then receive and/or send the second part of information based on the transmission configuration, so as to report data. Thus, a first device at a receiving end obtains the data from the backscatter communication device in a timely manner, and then further reacts.

Optionally, in this embodiment of this application, the first device may be a gNB or a reader. The backscatter communication device may be a tag. Generally, a backscatter communication device is not powered by using a battery, but is powered by collecting radio frequency signals in an environment. A backscatter communication device may also be referred to as a passive device, a reflector, a backscatter terminal, a semi-passive device, a signal scattering device, or the like.

Specifically, in an application scenario of a fire alarm sensor, a passive backscatter communication device is deployed to reduce costs for deploying a large quantity of backscatter communication devices. A first device continuously or periodically sends continuous waves (Continuous Wave, CW). The backscatter communication device may autonomously report information depending on a need (for example, the backscatter communication device detects a fire). In the reporting process, according to steps 201 and 202, a transmission configuration of a second part of information is determined based on a first part of information, and the second part of information is received and/or sent based on the transmission configuration. In this way, the first device does not need to trigger, in a downlink direction, data reporting by the backscatter communication device; and can obtain, in a timely manner, the information actively reported by the backscatter communication device, and further react. Further, provided that the backscatter communication device chooses to report autonomously, it indicates that an exception has occurred, for example, a fire has occurred. This prevents a plurality of inventories on the first device side and prevents frequent responses on the backscatter communication device side, and all feedback of the backscatter communication device is valid, significantly improving efficiency. Certainly, the method in this embodiment of this application may further be applied to scenarios in which there is a small probability that an exception of temperature, motion, vibration, air quality, humidity, radiation, or the like occurs, but an occurrence of the exception has a serious consequence. The scenarios are not listed one by one herein.

Optionally, in some embodiments, the first part of information is information received and/or sent by the backscatter communication device prior to the second part of information.

Optionally, in some embodiments, the first part of information includes at least some information in first information, second information, third information, and fourth information, and the second part of information includes at least some information, other than the first part of information, in the first information, the second information, the third information, and the fourth information; or

the first part of information includes one of the third information and the fourth information, and the second part of information includes the other of the third information and the fourth information.

The first information is used for an uplink reporting request by the backscatter communication device, the second information is used for an uplink reporting response by the first device, the third information is used for uplink data transmission by the backscatter communication device, and the fourth information is used for an uplink data acknowledgment by the first device.

Herein, the first information is an uplink signal, the second information is a downlink signal, the third information is an uplink signal, and the fourth information is a downlink signal. Specifically, the first information may include a reporting request sent by the backscatter communication device to the first device, the second information may include a reporting response sent by the first device to the backscatter communication device, the third information may include data sent by the backscatter communication device to the first device, and the fourth information may include a data acknowledgment sent by the first device to the backscatter communication device.

Specifically, as shown in FIG. 3, first information (an Msg 1), second information (an Msg 2), third information (an Msg 3), and fourth information (an Msg 4) are transmitted between a backscatter communication device (for example, a tag) and a first device (for example, a gNB/reader), that is, the backscatter communication device performs autonomous reporting by following a 4-step uplink reporting (4-step uplink initiated reporting) procedure. Herein, the Msg 1 is mainly used for an uplink reporting request by the backscatter communication device, the Msg 2 is mainly used for a response made by the first device to the uplink reporting request by the backscatter communication device, the Msg 3 is mainly used for data reporting by the backscatter communication device, and the Msg 4 is mainly used for an acknowledgment made by the first device to data reporting by the backscatter communication device.

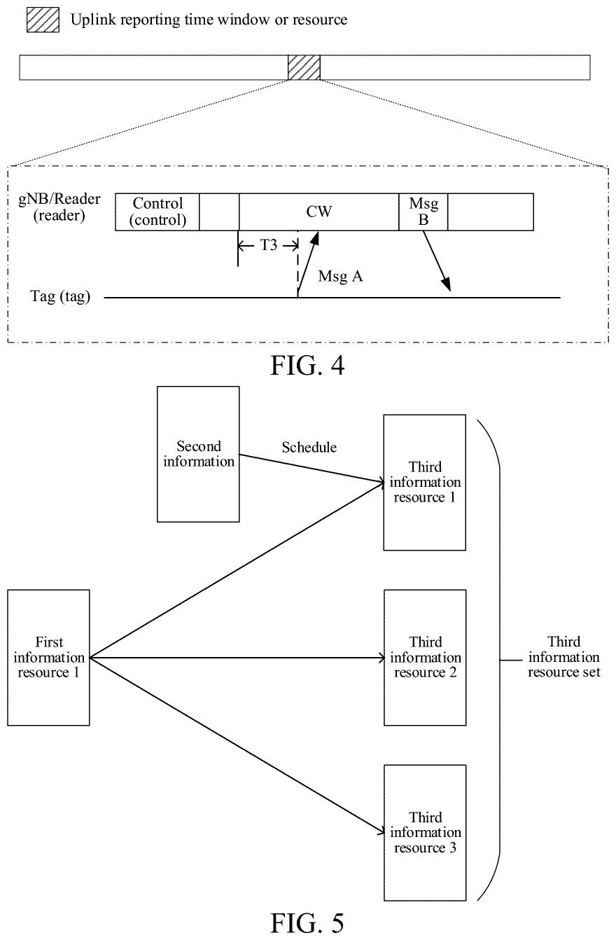

Alternatively, as shown in FIG. 4, third information (an Msg A) and fourth information (an Msg B) are transmitted between a backscatter communication device (for example, a tag) and a first device (for example, a gNB/reader), that is, the backscatter communication device performs autonomous reporting by following a 2-step uplink reporting (2-step uplink initiated reporting) procedure. Herein, the Msg A is mainly used for data reporting by the backscatter communication device, and the Msg B is mainly used for an acknowledgment made by the first device to data reporting by the backscatter communication device. Optionally, in some embodiments, step 201 includes:

the backscatter communication device determines the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information included in the second information, where the first indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; or
an association between an information-specific period of the first part of information and an information-specific period of the second part of information, where the information-specific period is an independent period of each piece of information.

The association between the transmission resource of the first information and the transmission resources of the third information may also be understood as a match between the transmission resources of the first information and the third information. For example, the first information and the third information use a same backscatter frequency domain resource, or an interval between a backscatter frequency domain resource position f₃ of the third information and a backscatter frequency domain resource position f₁ of the first information is a predefined or configured frequency (for example, f₃−f₁=Δf₁, where Δf₁ is a predefined or configured value); and/or an interval between a time domain resource position of the first information and a time domain resource position of the third information is predefined or configured time ΔT1.

The association between the transmission resource of the second information and the transmission resources of the third information may also be understood as a match between the transmission resources of the second information and the third information. For example, the match between the resources is predefined or configured, and transmission resources that match the transmission resource of the second information are the transmission resources of the third information.

The association between the transmission resource of the second information and the transmission resources of the fourth information may also be understood as a match between the transmission resources of the second information and the fourth information. For example, the second information and the fourth information use a same backscatter frequency domain resource, or an interval between a backscatter frequency domain resource position f₄ of the fourth information and a backscatter frequency domain resource position f₂ of the second information is a predefined or configured frequency (for example, f₄−f₂=Δf₂, where Δf₂ is a predefined or configured value); and/or an interval between a time domain resource position of the second information and a time domain resource position of the fourth information is predefined or configured time ΔT2.

The association between the transmission resource of the third information and the transmission resources of the fourth information may also be understood as a match between the transmission resources of the third information and the fourth information. For example, the third information and the fourth information use a same frequency domain resource, or an interval between a frequency domain resource position f₄ of the fourth information and a frequency domain resource position f₃ of the third information is a predefined or configured frequency (for example, f₄−f₃−Δf₃, where Δf₃ is a predefined or configured value); and/or an interval between a time domain resource position of the third information and a time domain resource position of the fourth information is predefined or configured time ΔT3.

It should be noted that dynamic authorization of the third information may be skipped to schedule the fourth information in backscatter communication.

The second information includes the first indication information. It may be learned that the second information may be used to schedule the transmission resource of the third information or the fourth information, and the first indication information is transmission resource scheduling information.

It should be noted that dynamic authorization of the second information may be skipped to schedule the third information or the fourth information in backscatter communication.

The interval between the frequency domain resource position of the first part of information and the frequency domain resource position of the second part of information may indicate that there is a same frequency separation between the pieces of information. For example, an interval between frequency domain resource positions is predefined or configured as Δf, and frequency domain resource positions of the first information, the second information, the third information, and the fourth information are f₁, f₂, f₃, and f₄, respectively. In this case, f₂−f₁=f₃−f₂=f₄−f₃=Δf. Alternatively, the interval between the frequency domain resource position of the first part of information and the frequency domain resource position of the second part of information may indicate that there are different frequency separations between the pieces of information. For example, intervals between frequency domain resource positions are predefined or configured as Δf₁, Δf₂, and Δf₃, and frequency domain resource positions of the first information, the second information, the third information, and the fourth information are f₁, f₂, f₃, and f₄, respectively. In this case, f₃−f₁=Δf₁, f₄−f₂=Δf₂, and f₄−f₃=Δf₃.

The interval between the time domain resource position of the first part of information and the time domain resource position of the second part of information may indicate that there is a same time interval between the pieces of information. For example, an interval between time domain resource positions is predefined or configured as Δt, and time domain resource positions of the first information, the second information, the third information, and the fourth information are t₁, t₂, t₃, and t₄, respectively. In this case, t₂−t₁=t₃−t₂=t₄−t₃=Δt. Alternatively, the interval between the time domain resource position of the first part of information and the time domain resource position of the second part of information may indicate that there are different time intervals between the pieces of information. For example, intervals between time domain resource positions are predefined or configured as Δt₁, At₂, and At₃, and time domain resource positions of the first information, the second information, the third information, and the fourth information are t₁, t₂, t₃, and t₄, respectively. In this case, t₃−t₁=Δt₁, t₄−t₂=Δt₂, and t₄−t₃=Δt₃.

The transmission resources of the first part of information and the second part of information are in the same period. This period may be understood as a common period. For example, a first common period is an uplink reporting time window or resource for transmitting the first information, the second information, the third information, and the fourth information; or a second common period is an uplink reporting time window or resource for transmitting the third information and the fourth information.

The association between the information-specific period of the first part of information and the information-specific period of the second part of information indicates a mapping relationship between the periods independently configured for the pieces of information. An example in which the first part of information is the first information and the second part of information is the third information is used. The association between the information-specific period of the first part of information and the information-specific period of the second part of information may be that a period of the first information is a multiple of a period of the third information, and may be that each period of the first information may be mapped to a plurality of periods of the third information. Finally, a period used for the third information may be further determined in the plurality of periods based on the transmission resource scheduling information in the second information, a reporting type, a reporting priority, or the like. Certainly, when a requirement on reliability is high, the third information may alternatively be transmitted repeatedly in the plurality of periods.

A period is independently configured for each piece of information, with a multiple relationship existing between the periods. Thus, for a single backscatter communication device, acknowledgments of a plurality of pieces of reported information can be bound to one feedback, reducing occupation of resources. For example, a period of the fourth information may be a multiple of a period of the third information. In this case, after receiving a plurality of pieces of third information, the first device may transmit acknowledgments of the pieces of third information on one transmission resource (feedback resource).

Certainly, the transmission configuration may alternatively be determined based on an association between the transmission resource of the first information and transmission resources of the second information, or an association between the transmission resource of the first information and the transmission resources of the fourth information. Details are not described herein.

Optionally, in some embodiments, the association between the transmission resource of the first information and the transmission resources of the third information indicates an information resource set associated with the transmission resource of the first information, and the information resource set includes a plurality of groups of (a plurality of) transmission resources of the third information.

To be specific, the backscatter communication device can determine the plurality of groups of (the plurality of) transmission resources based on the transmission resource of the first information and the association between the transmission resource of the first information and the transmission resources of the third information. The plurality of groups of (the plurality of) transmission resources are all allowed for data reporting. Certainly, the backscatter communication device may transmit data on the plurality of groups of (the plurality of) transmission resources; or may further determine one or more groups of (one or more) transmission resources for data reporting, for example, determine as indicated by the first indication information in the second information. For example, as shown in FIG. 5, after first information is sent by using a transmission resource of the first information (a first information resource 1), candidate transmission resources of third information can be determined according to a plurality of transmission resources of the third information, that is, a third information resource set {a third information resource 1, a third information resource 2, and a third information resource 3}, corresponding to the first information resource 1. Then, the third information resource 1 is scheduled based on first indication information, and it is determined that the third information is finally transmitted on the third information resource 1.

Optionally, in some embodiments, the association between the transmission resource of the third information and the transmission resources of the fourth information indicates an information resource set associated with the transmission resource of the third information, and the information resource set includes a plurality of groups of (a plurality of) transmission resources of the fourth information.

To be specific, after the third information is sent, the backscatter communication device can determine the plurality of groups of (the plurality of) transmission resources based on the transmission resource of the third information and the association between the transmission resource of the third information and the transmission resources of the fourth information. The plurality of groups of (the plurality of) transmission resources are all allowed for a data reporting acknowledgment. Certainly, the first device may transmit an uplink data acknowledgment on the plurality of groups of (the plurality of) transmission resources; or may further determine one or more groups of (one or more) transmission resources for a data reporting acknowledgment, for example, determine as indicated by the first indication information in the second information.

Optionally, in some embodiments, in a case that the transmission resources of the first part of information and the second part of information are in the same period, the period includes the transmission resource of the first information, the transmission resource of the second information, the transmission resource of the third information, and the transmission resource of the fourth information; or the period includes the transmission resource of the third information and the transmission resource of the fourth information.

To be specific, for the period that the transmission resources of the first part of information and the second part of information are in, uplink and downlink resources are automatically matched. For example, only one transmission resource of the first information, one transmission resource of the second information, one transmission resource of the third information, and one transmission resource of the fourth information are configured in each first common period. The backscatter communication device performs uplink reporting in each selected period. In this case, each piece of information automatically matches the configured transmission resource. The first common period is applicable to 4-step uplink initiated reporting. For example, only one transmission resource of the third information and one transmission resource of the fourth information are configured in each second common period. The backscatter communication device performs uplink reporting in each selected period. In this case, each piece of information automatically matches the configured transmission resource. The second common period is applicable to 2-step uplink initiated reporting.

Optionally, in some embodiments, the first information and/or the third information are/is transmitted in backscatter communication mode.

For 4-step uplink initiated reporting, the first information and the third information are sent by the backscatter communication device. For 2-step uplink initiated reporting, the third information is sent by the backscatter communication device.

Optionally, in some embodiments, an interval between the periods of the first information and the third information, and/or an interval between the periods of the third information and the fourth information are/is determined by at least one of the following:
a predefinition or a configuration;
minimum energy supply duration required for a continuous wave to send information; or
a type of uplink reporting initiation.

Herein, the interval between the periods of the first information and the third information is the interval between the period of the first information (a first information-specific period) and the period of the third information (a third information-specific period). The interval between the periods of the third information and the fourth information is the interval between the period of the third information (a third information-specific period) and the period of the fourth information (a fourth information-specific period).

In a case that a period interval is determined by the minimum energy supply duration required for a continuous wave to send information, the minimum energy supply duration is minimum energy supply duration required for a continuous wave to send the third information.

The type of uplink reporting initiation may be contention-based, that is, 4-step uplink initiated reporting, or may be contention-free, that is, 2-step uplink initiated reporting. It should be learned that, in a scenario with a large quantity of backscatter communication devices, uplink reporting is performed based on contention, ensuring that the backscatter communication devices report data only after receiving responses to reporting requests, and ensuring validity of data reporting; in a scenario with a small quantity of backscatter communication devices, uplink reporting is contention-free, reducing a reporting procedure and reducing resources. Optionally, in some embodiments, the transmission resource of the first information and/or the transmission resource of the third information are/is determined by at least one of the following:
a random resource in a resource pool;
a service priority; or
a type of uplink reporting initiation.

The resource pool is predefined or configured. Further, for contention-based uplink initiated reporting and contention-free uplink initiated reporting, the predefined or configured resource pools are different.

Specifically, a random resource randomly selected from the resource pool may be used as the transmission resource of the first information and/or the transmission resource of the third information; a resource with a higher or lower priority may be selected as the transmission resource of the first information and/or the transmission resource of the third information based on service priorities of resources; or a resource corresponding to the type of uplink reporting initiation may be used as the transmission resource of the first information and/or the transmission resource of the third information. Alternatively, a combination of two or more of the foregoing items may be used for determining. For example, a plurality of random resources are randomly selected from the resource pool; further, based on service priorities of the plurality of random resources, a resource with a higher or lower priority is selected as the transmission resource of the first information and/or the transmission resource of the third information. Certainly, there may further be other determining manners, which are not listed one by one herein.

Specifically, for 4-step uplink initiated reporting, the transmission resource of the first information is determined by the at least one of a random resource in the resource pool, the service priority, or the type of uplink reporting initiation; and the transmission resources of the second information, the third information, and the fourth information are determined based on at least one of the associations, the first indication information, the interval between the frequency domain resource positions, the interval between the time domain resource positions, the first common period, or the association between the information-specific periods. For example, as shown in FIG. 3, an interval between an Msg 1 sending time and a CW sending time is T1, and an interval between an Msg 3 sending time and an Msg 2 receiving time is T2.

For 2-step uplink initiated reporting, the transmission resource of the third information is determined by the at least one of a random resource in the resource pool, the service priority, or the type of uplink reporting initiation (for example, as shown in FIG. 4, an interval between an Msg A sending time and a CW sending time is T3); and the transmission resource of the fourth information (Msg B) is determined based on at least one of the association between the transmission resource of the third information and the transmission resources of the fourth information, the first indication information, the interval between the frequency domain resource positions, the interval between the time domain resource positions, the second common period, or an association between the periods (information-specific periods) of the third information and the fourth information.

Certainly, the transmission resource of at least one of the first information, the second information, the third information, or the fourth information may alternatively be determined by a predefinition or a configuration.

Optionally, in some embodiments, the transmission configuration includes at least one of the following:
a transmission resource;
a coding scheme;
preamble (preamble) information;
data information;
a cyclic redundancy check (Cyclic Redundancy Check, CRC);
a downlink chip rate (chip rate);
a data rate (data rate);
an information bit (bit); or
a modulation method.

The modulation method may be (On-Off Keying, OOK), or may be frequency-shift keying (Frequency-Shift Keying, FSK). The modulation method is used as an example. A same modulation method may be predefined or configured for the pieces of information, or an independent modulation method is predefined or configured for each piece of information. For example, the second information and the fourth information use a same modulation method.

It should be noted that, in some embodiments, the first device configures a reporting request and/or an uplink data transmission configuration for uplink reporting triggered by the backscatter communication device. For example, for 4-step uplink initiated reporting, the first device configures the transmission resource for the first information; and for 2-step uplink initiated reporting, the first device configures the transmission resource for the third information.

Optionally, in some embodiments, the first information further includes device information of the backscatter communication device and/or some data.

In other words, the first information includes the reporting request, or the first information includes the reporting request, and the device information (for example, a device identifier tagID) of the backscatter communication device and/or the some data. In a case that the first information includes the some data, the third information may include only some of remaining data, or may include all data.

Optionally, in some embodiments, the third information includes the device information of the backscatter communication device.

For example, for 2-step uplink initiated reporting, the third information includes data and/or the device information of the backscatter communication device, for example, tagID.

It should be noted that the transmission resource includes a time domain resource and/or a frequency domain resource. Specifically, a time domain resource includes at least one of a sending start moment, a sending time offset, or system reference time (for example, a system frame number (System Frame Number, SFN)); and a frequency domain resource includes carrier frequency information and/or a bandwidth of a backscatter communication channel of a signal.

It should be noted that the foregoing configuration may be configured by a network device or a reader.

The following describes, with reference to an accompanying drawing, the transmission resources determined for the first information, the second information, the third information, and the fourth information in this embodiment of this application.

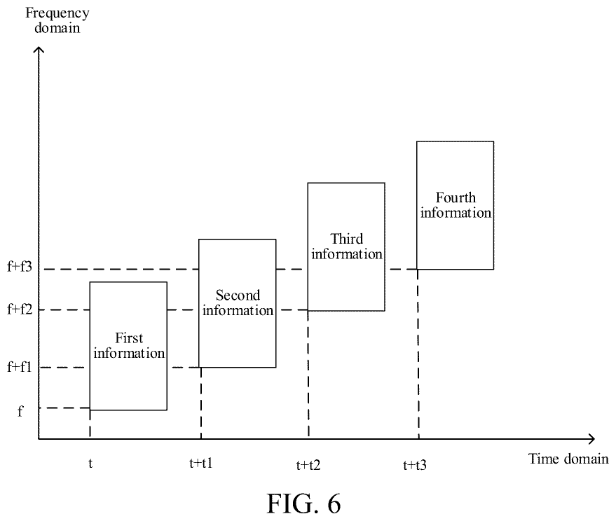

In a case, there are equal intervals between the transmission resources (that is, occupied time-frequency resources) of the first information, the second information, the third information, and the fourth information, that is, equal time intervals in time domain, and equal frequency separations in frequency domain. As shown in FIG. 6, t3=3×t1, t2=2×t1, f₃₌₃×f₁, and f2=2×f1.

In a case, there are fixed intervals between the time-frequency resources of the different pieces of information, and the intervals are not necessarily equal.

In another case, the different pieces of information are in an order in time domain and need to be staggered, but may occupy a same frequency domain resource in frequency domain. For example, the first information and the third information are both uplink, so frequency domain positions of the first information and the third information are the same; and the second information and the fourth information are both downlink, so frequency domain positions of the second information and the fourth information are the same.

Certainly, in an autonomous reporting process, uplink reporting-related information transmitted between the backscatter communication device and the first device is not limited to 4-step uplink initiated reporting and 2-step uplink initiated reporting, and may alternatively be M-step uplink initiated reporting, where M is an integer greater than or equal to 1. The method in this embodiment of this application is also applicable to M-step uplink initiated reporting.

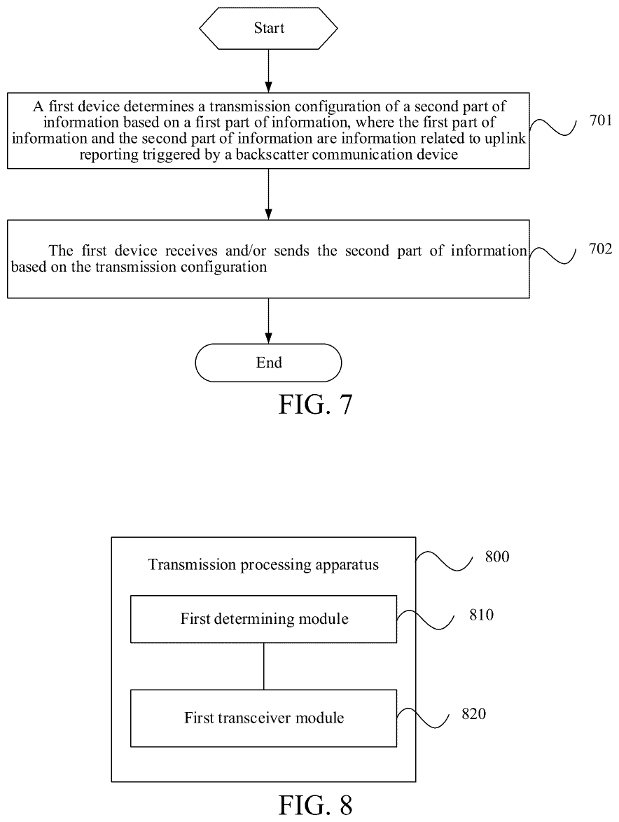

As shown in FIG. 7, a transmission processing method according to an embodiment of this application includes the following steps.

Step 701: A first device determines a transmission configuration of a second part of information based on a first part of information, where the first part of information and the second part of information are information related to uplink reporting triggered by a backscatter communication device.

Herein, uplink reporting triggered by the backscatter communication device is an autonomous reporting procedure triggered by the backscatter communication device in a specific situation. The first part of information and the second part of information are both information in the reporting procedure; and may be information received by the backscatter communication device, or may be information sent by the backscatter communication device. Thus, in this step, for autonomous uplink reporting triggered by the backscatter communication device in the specific situation, the first device determines the transmission configuration of the second part of information based on the first part of information.

Step 702: The first device receives and/or sends the second part of information based on the transmission configuration.

In this step, the first device can receive and/or send the second part of information based on the transmission configuration after determining the transmission configuration in step 701.

According to the foregoing steps, for autonomous uplink reporting triggered by the backscatter communication device in the specific situation, the first device can determine the transmission configuration of the second part of information based on the first part of information, and then receive and/or send the second part of information based on the transmission configuration, so as to cooperate with the backscatter communication device to report data. Thus, the first device obtains, in a timely manner, the data that the backscatter communication device needs to report.

Optionally, the first part of information includes at least some information in first information, second information, third information, and fourth information, and the second part of information includes at least some information, other than the first part of information, in the first information, the second information, the third information, and the fourth information; or

the first part of information includes one of the third information and the fourth information, and the second part of information includes the other of the third information and the fourth information.

The first information is used for an uplink reporting request by the backscatter communication device, the second information is used for an uplink reporting response by the first device, the third information is used for uplink data transmission by the backscatter communication device, and the fourth information is used for an uplink data acknowledgment by the first device.

Optionally, that the first device determines the transmission configuration of the second part of information based on the first part of information includes:
the first device determines the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information included in the second information, where the indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; or
an association between an information-specific period of the first part of information and an information-specific period of the second part of information, where the information-specific period is an independent period of each piece of information.

Optionally, the association between the transmission resource of the first information and the transmission resources of the third information indicates an information resource set associated with the transmission resource of the first information, and the information resource set includes a plurality of groups of transmission resources of the third information.

Optionally, in a case that the transmission resources of the first part of information and the second part of information are in the same period, the period includes the transmission resource of the first information, the transmission resource of the second information, the transmission resource of the third information, and the transmission resource of the fourth information; or
the period includes the transmission resource of the third information and the transmission resource of the fourth information.

Optionally, an interval between periods of the first information and the third information, and/or an interval between periods of the third information and the fourth information are/is determined by at least one of the following:
a predefinition or a configuration;
minimum energy supply duration required for a continuous wave to send information; or a type of uplink reporting initiation.

Optionally, the transmission resource of the first information and/or the transmission resource of the third information are/is determined by at least one of the following:
a random resource in a resource pool;
a service priority; or
a type of uplink reporting initiation.

Optionally, the association between the transmission resource of the third information and the transmission resources of the fourth information indicates an information resource set associated with the transmission resource of the third information, and the information resource set includes a plurality of groups of transmission resources of the fourth information.

Optionally, the transmission configuration includes at least one of the following:
a transmission resource;
a modulation method;
a coding scheme;
preamble information;
data information;
a CRC;
a downlink chip rate;
a data rate; or
an information bit.

Optionally, the first information further includes device information of the backscatter communication device and/or some data.

It should be noted that the method in this embodiment of this application is implemented in cooperation with the foregoing method performed by the backscatter communication device, the implementation of the foregoing method embodiment is applicable to this embodiment of this application, and the same technical effects can also be achieved.

The transmission processing method provided in this embodiment of this application may be performed by a transmission processing apparatus. In embodiments of this application, the transmission processing apparatus provided in embodiments of this application is described by using an example in which the transmission processing apparatus performs the transmission processing method.

As shown in FIG. 8, a transmission processing apparatus 800 according to an embodiment of this application includes:
a first determining module 810, configured to determine a transmission configuration of a second part of information based on a first part of information, where the first part of information and the second part of information are information related to uplink reporting triggered by a backscatter communication device; and
a first transceiver module 820, configured to receive and/or send the second part of information based on the transmission configuration.

Optionally, the first part of information includes at least some information in first information, second information, third information, and fourth information, and the second part of information includes at least some information, other than the first part of information, in the first information, the second information, the third information, and the fourth information; or
the first part of information includes one of the third information and the fourth information, and the second part of information includes the other of the third information and the fourth information.

The first information is used for an uplink reporting request by the backscatter communication device, the second information is used for an uplink reporting response by a first device, the third information is used for uplink data transmission by the backscatter communication device, and the fourth information is used for an uplink data acknowledgment by the first device.

Optionally, the first determining module 810 is further configured to:
determine the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information included in the second information, where the indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; or
an association between an information-specific period of the first part of information and an information-specific period of the second part of information, where the information-specific period is an independent period of each piece of information.

Optionally, the association between the transmission resource of the first information and the transmission resources of the third information indicates an information resource set associated with the transmission resource of the first information, and the information resource set includes a plurality of groups of transmission resources of the third information.

Optionally, in a case that the transmission resources of the first part of information and the second part of information are in the same period, the period includes the transmission resource of the first information, the transmission resource of the second information, the transmission resource of the third information, and the transmission resource of the fourth information; or the period includes the transmission resource of the third information and the transmission resource of the fourth information.

Optionally, an interval between periods of the first information and the third information, and/or an interval between periods of the third information and the fourth information are/is determined by at least one of the following:
a predefinition or a configuration;
minimum energy supply duration required for a continuous wave to send information; or
a type of uplink reporting initiation.

Optionally, the transmission resource of the first information and/or the transmission resource of the third information are/is determined by at least one of the following:
a random resource in a resource pool;
a service priority; or
a type of uplink reporting initiation.

Optionally, the association between the transmission resource of the third information and the transmission resources of the fourth information indicates an information resource set associated with the transmission resource of the third information, and the information resource set includes a plurality of groups of transmission resources of the fourth information.

Optionally, the transmission configuration includes at least one of the following:
a transmission resource;
a modulation method;
a coding scheme;
preamble information;
data information;
a CRC;
a downlink chip rate;
a data rate; or
an information bit.

Optionally, the first information further includes device information of the backscatter communication device and/or some data.

The apparatus in this embodiment of this application may be a tag. Specifically, the tag may be a passive IoT (Passive-IoT) device, may be a semi-passive (semi-passive) tag, or may be a tag with an active sending capability (active tag).

The apparatus provided in this embodiment of this application can implement the processes implemented by the method embodiment in FIG. 2 to FIG. 6, and the same technical effects are achieved. To avoid repetition, details are not described herein again.

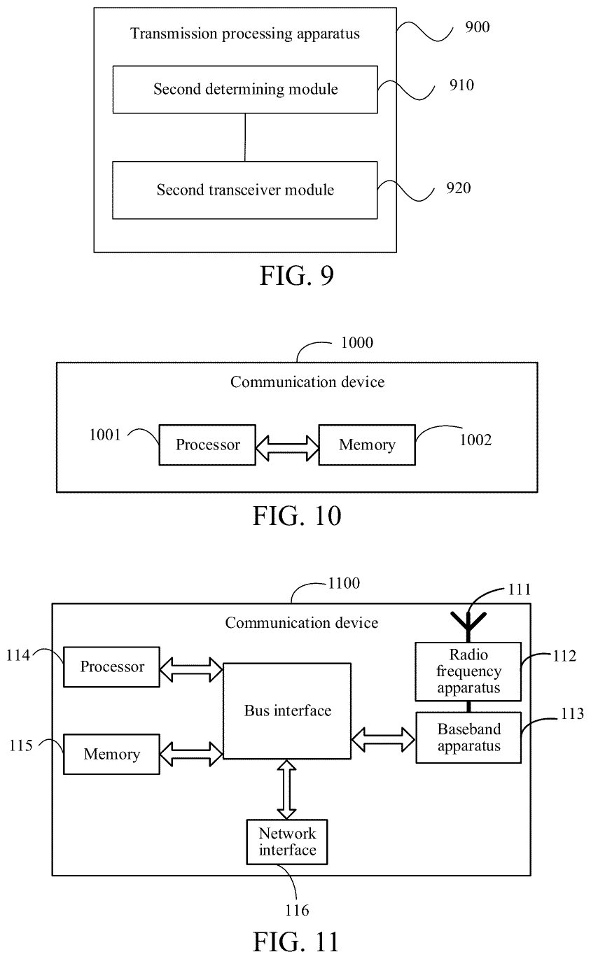

As shown in FIG. 9, a transmission processing apparatus 900 according to an embodiment of this application includes:
a second determining module 910, configured to determine a transmission configuration of a second part of information based on a first part of information, where the first part of information and the second part of information are information related to uplink reporting triggered by a backscatter communication device; and
a second transceiver module 920, configured to receive and/or send the second part of information based on the transmission configuration.

Optionally, the first part of information includes at least some information in first information, second information, third information, and fourth information, and the second part of information includes at least some information, other than the first part of information, in the first information, the second information, the third information, and the fourth information; or
the first part of information includes one of the third information and the fourth information, and the second part of information includes the other of the third information and the fourth information.

The first information is used for an uplink reporting request by the backscatter communication device, the second information is used for an uplink reporting response by a first device, the third information is used for uplink data transmission by the backscatter communication device, and the fourth information is used for an uplink data acknowledgment by the first device.

Optionally, the second determining module 910 is further configured to:
determine the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information included in the second information, where the indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; or
an association between an information-specific period of the first part of information and an information-specific period of the second part of information, where the information-specific period is an independent period of each piece of information.

Optionally, the association between the transmission resource of the first information and the transmission resources of the third information indicates an information resource set associated with the transmission resource of the first information, and the information resource set includes a plurality of groups of transmission resources of the third information.

Optionally, in a case that the transmission resources of the first part of information and the second part of information are in the same period, the period includes the transmission resource of the first information, the transmission resource of the second information, the transmission resource of the third information, and the transmission resource of the fourth information; or the period includes the transmission resource of the third information and the transmission resource of the fourth information.

Optionally, an interval between periods of the first information and the third information, and/or an interval between periods of the third information and the fourth information are/is determined by at least one of the following:
a predefinition or a configuration;
minimum energy supply duration required for a continuous wave to send information; or
a type of uplink reporting initiation.

Optionally, the transmission resource of the first information and/or the transmission resource of the third information are/is determined by at least one of the following:
a random resource in a resource pool;
a service priority; or
a type of uplink reporting initiation.

Optionally, the association between the transmission resource of the third information and the transmission resources of the fourth information indicates an information resource set associated with the transmission resource of the third information, and the information resource set includes a plurality of groups of transmission resources of the fourth information.

Optionally, the transmission configuration includes at least one of the following: a transmission resource; a modulation method; a coding scheme; preamble information; data information; a CRC; a downlink chip rate; a data rate; or an information bit.

Optionally, the first information further includes device information of the backscatter communication device and/or some data.

The apparatus in this embodiment of this application may be an electronic device, for example, an electronic device with an operating system, or may be a component in an electronic device, for example, an integrated circuit or a chip. The electronic device may be a gNB, or may be a reader, or may be a device other than a gNB and a reader.

The apparatus provided in this embodiment of this application can implement the processes implemented by the method embodiment in FIG. 7, and the same technical effects are achieved. To avoid repetition, details are not described herein again.

Optionally, as shown in FIG. 10, an embodiment of this application further provides a communication device 1000, including a processor 1001 and a memory 1002. The memory 1002 stores a program or instructions executable on the processor 1001. For example, when the communication device 1000 is a backscatter communication device and when the program or the instructions are executed by the processor 1001, the steps in the foregoing embodiment of the transmission processing method performed by the backscatter communication device are implemented, and the same technical effects can be achieved; when the communication device 1000 is a first device and when the program or the instructions are executed by the processor 1001, the steps in the foregoing embodiment of the transmission processing method performed by the first device are implemented, and the same technical effects can be achieved. To avoid repetition, details are not described herein again.

An embodiment of this application further provides a backscatter communication device, including a processor and a communication interface. The processor is configured to determine a transmission configuration of a second part of information based on a first part of information, where the first part of information and the second part of information are information related to uplink reporting triggered by the backscatter communication device. The communication interface is configured to receive and/or send the second part of information based on the transmission configuration.

The communication device embodiment corresponds to the foregoing method embodiment on the backscatter communication device side. The implementation processes and the implementation manners of the foregoing method embodiment may all be applicable to the backscatter communication device embodiment, and the same technical effects can be achieved.

An embodiment of this application further provides a communication device, including a processor and a communication interface. The processor is configured to determine a transmission configuration of a second part of information based on a first part of information, where the first part of information and the second part of information are information related to uplink reporting triggered by a backscatter communication device. The communication interface is configured to receive and/or send the second part of information based on the transmission configuration. The communication device embodiment corresponds to the foregoing method embodiment of the first device. The implementation processes and the implementation manners of the foregoing method embodiment may all be applicable to the communication device embodiment, and the same technical effects can be achieved.

Specifically, this embodiment of this application further provides a communication device 1100. As shown in FIG. 11, the communication device 1100 includes an antenna 111, a radio frequency apparatus 112, a baseband apparatus 113, a processor 114, and a memory 115. The antenna 111 is connected to the radio frequency apparatus 112. In an uplink direction, the radio frequency apparatus 112 receives information by using the antenna 111, and sends the received information to the baseband apparatus 113 for processing. In a downlink direction, the baseband apparatus 113 processes information to be sent, and sends the information to the radio frequency apparatus 112. The radio frequency apparatus 112 processes the received information, and sends the information by using the antenna 111.

The method performed by the first device in the foregoing embodiment may be implemented in the baseband apparatus 113. The baseband apparatus 113 includes a baseband processor.

The baseband apparatus 113 may include, for example, at least one baseband board. A plurality of chips are disposed on the baseband board. As shown in FIG. 11, one of the chips is, for example, the baseband processor, which is connected to the memory 115 through a bus interface to invoke a program in the memory 115 to perform the operations of the first device shown in the foregoing method embodiment.

The communication device 1100 may further include a network interface 116. The interface is, for example, a common public radio interface (common public radio interface, CPRI).

Specifically, the communication device 1100 in this embodiment of the present invention further includes instructions or the program stored in the memory 115 and executable on the processor 114. The processor 114 invokes the instructions or the program in the memory 115, to perform the method performed by the modules shown in FIG. 9, and the same technical effects are achieved. To avoid repetition, details are not described herein again.

An embodiment of this application further provides a readable storage medium. The readable storage medium stores a program or instructions. When the program or the instructions are executed by a processor, the processes in the foregoing embodiment of the transmission processing method performed by the backscatter communication device are implemented, or the processes in the foregoing embodiment of the transmission processing method performed by the first device are implemented; and the same technical effects can be achieved. To avoid repetition, details are not described herein again.

The processor is the processor in the terminal described in the foregoing embodiments. The readable storage medium includes a computer-readable storage medium, such as a computer read-only memory (Read-Only Memory, ROM), a random access memory (Random Access Memory, RAM), a magnetic disk, or an optical disc.

An embodiment of this application further provides a chip. The chip includes a processor and a communication interface. The communication interface is coupled to the processor. The processor is configured to run a program or instructions, to implement the processes in the foregoing embodiment of the transmission processing method performed by the backscatter communication device, or to implement the processes in the foregoing embodiment of the transmission processing method performed by the first device; and the same technical effects can be achieved. To avoid repetition, details are not described herein again.

It should be understood that the chip mentioned in this embodiment of this application may also be referred to as a system on chip, a system chip, a chip system, a system-on-chip, or the like.

An embodiment of this application further provides a computer program/program product. The computer program/program product is stored in a storage medium. The computer program/program product is executed by at least one processor, to implement the processes in the foregoing embodiment of the transmission processing method performed by the backscatter communication device, or to implement the processes in the foregoing embodiment of the transmission processing method performed by the first device; and the same technical effects can be achieved. To avoid repetition, details are not described herein again.

An embodiment of this application further provides a transmission processing system, including a backscatter communication device and a first device. The backscatter communication device may be configured to perform the steps of the transmission processing method performed by the backscatter communication device as described above, and the first device may be configured to perform the steps of the transmission processing method performed by the first device as described above.

In embodiments of this application, for the information related to uplink reporting triggered by the backscatter communication device, the backscatter communication device can determine the transmission configuration of the second part of information based on the first part of information, and then receive and/or send the second part of information based on the transmission configuration, so as to report data. Thus, the first device at a receiving end obtains, in a timely manner, the data that the backscatter communication device needs to report.

It should be noted that the term “include”, “comprise”, or any other variation thereof in this specification is intended to cover a non-exclusive inclusion, so that a process, a method, an object, or an apparatus that includes a series of elements not only includes those elements but also includes other elements that are not clearly listed, or further includes elements inherent to the process, the method, the object, or the apparatus. In absence of more constraints, an element preceded by “includes a . . . ” does not preclude existence of other identical elements in the process, the method, the object, or the apparatus that includes the element. In addition, it should be noted that in the scope of the method and the apparatus in embodiments of this application, an order in which functions are performed is not limited to the shown or discussed order, and may further include an order in which the functions are substantially performed at the same time or a reverse order, depending on the related functions. For example, the described method may be performed in an order different from the described order, and steps may be added, omitted, or combined. Moreover, features described with reference to some examples may be combined in other examples.

According to the descriptions of the foregoing implementations, a person skilled in the art can clearly understand that the method according to the foregoing embodiments may be implemented by software and a necessary universal hardware platform or by hardware only. In some cases, the former can be a preferred implementation. Based on such an understanding, the technical solutions of this application essentially, or the part contributing to the conventional technology, may be presented in a form of a computer software product. The computer software product is stored in a storage medium (for example, a ROM/RAM, a magnetic disk, or an optical disc), including several instructions used to enable a terminal (which may be a mobile phone, a computer, a server, an air conditioner, a network device, or the like) to perform the method described in embodiments of this application.

Embodiments of this application are described above with reference to the accompanying drawings. However, this application is not limited to the foregoing specific implementations. The foregoing specific implementations are merely illustrative rather than restrictive. Inspired by this application, a person of ordinary skill in the art can still derive a lot of variations without departing from the essence of this application and the protection scope of the claims. All these variations shall fall within the protection of this application.

What is claimed is:

1. A transmission processing method, comprising:
determining, by a backscatter communication device, a transmission configuration of a second part of information based on a first part of information, wherein the first part of information and the second part of information are information related to uplink reporting triggered by the backscatter communication device; and
receiving and/or sending, by the backscatter communication device, the second part of information based on the transmission configuration.

2. The method according to claim 1, wherein the first part of information comprises at least some information in first information, second information, third information, and fourth information, and the second part of information comprises at least some information, other than the first part of information, in the first information, the second information, the third information, and the fourth information; or
the first part of information comprises one of the third information and the fourth information, and the second part of information comprises the other of the third information and the fourth information, wherein
the first information is used for an uplink reporting request by the backscatter communication device, the second information is used for an uplink reporting response by a first device, the third information is used for uplink data transmission by the backscatter communication device, and the fourth information is used for an uplink data acknowledgment by the first device.

3. The method according to claim 2, wherein the determining, by a backscatter communication device, a transmission configuration of a second part of information based on a first part of information comprises:
determining, by the backscatter communication device, the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information comprised in the second information, wherein the first indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; and
an association between an information-specific period of the first part of information and an information-specific period of the second part of information, wherein the information-specific period is an independent period of each piece of information.

4. The method according to claim 3, wherein the association between the transmission resource of the first information and the transmission resources of the third information indicates an information resource set associated with the transmission resource of the first information, and the information resource set comprises a plurality of groups of transmission resources of the third information.

5. The method according to claim 3, wherein in a case that the transmission resources of the first part of information and the second part of information are in the same period, the period comprises the transmission resource of the first information, the transmission resource of the second information, the transmission resource of the third information, and the transmission resource of the fourth information; or the period comprises the transmission resource of the third information and the transmission resource of the fourth information.

6. The method according to claim 2, wherein at least one of: an interval between periods of the first information and the third information, and an interval between periods of the third information and the fourth information are determined by at least one of the following:
a predefinition or a configuration;
minimum energy supply duration required for a continuous wave to send information; and
a type of uplink reporting initiation.

7. The method according to claim 2, wherein at least one of a transmission resource of the first information and a transmission resource of the third information are determined by at least one of the following:
a random resource in a resource pool;
a service priority; and
a type of uplink reporting initiation.

8. The method according to claim 3, wherein the association between the transmission resource of the third information and the transmission resources of the fourth information indicates an information resource set associated with the transmission resource of the third information, and the information resource set comprises a plurality of groups of transmission resources of the fourth information.

9. The method according to claim 1, wherein the transmission configuration comprises at least one of the following:
a transmission resource;
a modulation method;
a coding scheme;
preamble information;
data information;
a cyclic redundancy check (CRC);
a downlink chip rate;
a data rate; and
an information bit.

10. The method according to claim 2, wherein the first information further comprises at least one of device information of the backscatter communication device and some data.

11. A transmission processing method, comprising:
determining, by a first device, a transmission configuration of a second part of information based on a first part of information, wherein the first part of information and the second part of information are information related to uplink reporting triggered by a backscatter communication device; and
at least one of receiving and sending, by the first device, the second part of information based on the transmission configuration.

12. The method according to claim 11, wherein the first part of information comprises at least some information in first information, second information, third information, and fourth information, and the second part of information comprises at least some information, other than the first part of information, in the first information, the second information, the third information, and the fourth information; or
the first part of information comprises one of the third information and the fourth information, and the second part of information comprises the other of the third information and the fourth information, wherein
the first information is used for an uplink reporting request by the backscatter communication device, the second information is used for an uplink reporting response by the first device, the third information is used for uplink data transmission by the backscatter communication device, and the fourth information is used for an uplink data acknowledgment by the first device.

13. The method according to claim 12, wherein the determining, by a first device, a transmission configuration of a second part of information based on a first part of information comprises:
determining, by the first device, the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information comprised in the second information, wherein the indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; and
an association between an information-specific period of the first part of information and an information-specific period of the second part of information, wherein the information-specific period is an independent period of each piece of information.

14. A backscatter communication device, comprising at least one hardware processor and a memory, wherein the memory stores a program or instructions executable on the processor, and when the program or the instructions are executed by the processor, the processor is configured to:
determine a transmission configuration of a second part of information based on a first part of information, wherein the first part of information and the second part of information are information related to uplink reporting triggered by the backscatter communication device; and
at least one of receive and send the second part of information based on the transmission configuration.

15. The device according to claim 14, wherein the first part of information comprises at least some information in first information, second information, third information, and fourth information, and the second part of information comprises at least some information, other than the first part of information, in the first information, the second information, the third information, and the fourth information; or
the first part of information comprises one of the third information and the fourth information, and the second part of information comprises the other of the third information and the fourth information, wherein
the first information is used for an uplink reporting request by the backscatter communication device, the second information is used for an uplink reporting response by a first device, the third information is used for uplink data transmission by the backscatter communication device, and the fourth information is used for an uplink data acknowledgment by the first device.

16. The device according to claim 15, wherein the processor is further configured to:
determine the transmission configuration based on at least one of the following:
an association between a transmission resource of the first information and transmission resources of the third information;
an association between a transmission resource of the second information and transmission resources of the third information;
an association between a transmission resource of the second information and transmission resources of the fourth information;
an association between a transmission resource of the third information and transmission resources of the fourth information;
first indication information comprised in the second information, wherein the first indication information indicates a transmission resource of the third information or the fourth information;
an interval between a frequency domain resource position of the first part of information and a frequency domain resource position of the second part of information;
an interval between a time domain resource position of the first part of information and a time domain resource position of the second part of information;
transmission resources of the first part of information and the second part of information are in a same period; and
an association between an information-specific period of the first part of information and an information-specific period of the second part of information, wherein the information-specific period is an independent period of each piece of information.

17. The device according to claim 16, wherein the association between the transmission resource of the first information and the transmission resources of the third information indicates an information resource set associated with the transmission resource of the first information, and the information resource set comprises a plurality of groups of transmission resources of the third information.

18. The device according to claim 17, wherein in a case that the transmission resources of the first part of information and the second part of information are in the same period, the period comprises the transmission resource of the first information, the transmission resource of the second information, the transmission resource of the third information, and the transmission resource of the fourth information; or the period comprises the transmission resource of the third information and the transmission resource of the fourth information.

19. The device according to claim 15, wherein at least one of an interval between periods of the first information and the third information, and an interval between periods of the third information and the fourth information are determined by at least one of the following:
a predefinition or a configuration;
minimum energy supply duration required for a continuous wave to send information; and
a type of uplink reporting initiation.

20. A communication device, comprising at least one hardware processor and a memory, wherein the memory stores a program or instructions executable on the processor, and when the program or the instructions are executed by the processor, the steps of the transmission processing method according to claim 11.
